(19) United States
(12) Patent Application Publication
(10) Pub. No.: US 2023/0257971 A1
(43) Pub. Date: Aug. 17, 2023

(54) A BUILDING FACILITY WATER MANAGEMENT METHOD AND SYSTEM

(71) Applicants: Caroma Industries Limited, New South Wales (AU); micas AG, Oelsnitz (DE)

(72) Inventors: Stephen John Cummings, New South Wales (AU); Michael Fritzsche, Neukirchen/Erzgebirge (DE); Mark Ebert, Oelsnitz/Erzgebirge (DE)

(21) Appl. No.: 18/004,841

(22) PCT Filed: Aug. 18, 2021
(86) PCT No.: PCT/AU2021/050908

§ 371 Date: Jan. 9, 2023

(30) Foreign Application Priority Data
Aug. 19, 2020 (AU) 2020902959

(51) Int. Cl. E03B 7/07

(52) U.S. Cl. CPC E03B 7/072

(57) ABSTRACT

A building facility water management method and system for controlling at least one operational parameter associated with a volume of water used by a water control device during a device operation of the water control device in a building facility is provided. The method and system allows for obtaining a water operation value associated with a volume of water for the water control device during the device operation; determining whether the water operation value is outside of a defined threshold associated with the device operation; upon a determination that the water operation value is outside of the defined threshold, adjusting an operational parameter associated with the water control device during the device operation to enable the water control device to be effectively operated.

### TECHNICAL FIELD

The present invention relates generally to a building facility water management method and system.

### BACKGROUND

Building facilities may include office buildings, hotels, motels, resorts, warehouse facilities, storage facilities, shopping malls, airports and the like.

In general, water control devices are devices that are used to provide water in a controlled manner using one or more operational parameters such as, for example, volume, flow rate, on/off timings etc. Water control devices may be connected to a water source to enable those devices to function as desired. These water control devices may be, for example, “end of line” plumbing fixtures such as tap ware, urinals, cisterns, showers, toilets, baths, bidets. The water control devices may also be water heater systems, water cooling towers etc.

For example, water control devices may be used in, or connected to, one or more environments or areas such as kitchens, bathrooms, restrooms, toilets and the like. For example, bathrooms, restrooms, toilets etc. may be referred to as “sanitary facilities”. A building facility may have one or more of these environments or areas. Each environment or area may be spread out over a large area and/or over two or more floors or levels.

As a specific example, the water control devices may be bathroom or restroom products in a sanitary facility, or water control devices that are associated with a sanitary facility. These may include baths, urinals, basins, shower heads, taps, toilets, bidets, water heater systems and water cooling towers for example. In general, each water control device (product) in a sanitary facility, or associated with a sanitary facility, may be referred to as a “sanitary installation”.

PCT publication WO2016/040989 by the present applicants entitled “Water Management System And Method” describes a system and method for controlling water control devices and is incorporated by reference herein in its entirety.

Water operations for the water control devices may operate on a fixed time operation using a water valve. However, the volume of water that is passed by the valve during the water operation may vary depending on a number of factors.

For example, the volume of water used during a flush can vary due to water pressure variations in the water supply.

Further, faults, such as blockages or leakages, in the water supply can result in a reduction in pressure and/or flow rate and so a reduction occurs in the volume of water used during a water operation.

Further, this problem may be exacerbated when water control devices are arranged to operate in different modes of operation.

Further, different types and designs within types of water control devices may require different volumes of water, flow rates and different water pressures in order to operate effectively (i.e. safely and/or efficiently and/or within set Standards).

### SUMMARY

It is an object of the present invention to substantially overcome, or at least ameliorate, one or more disadvantages of existing arrangements.

Disclosed are arrangements which seek to address the problems associated with the provision of water to water control devices to enable effective operation of those water control devices.

According to a first aspect of the present disclosure, there is provided a building facility water management method for controlling at least one operational parameter associated with a volume of water used by a water control device during a device operation of the water control device in a building facility, the method comprising the steps of: obtaining a water operation value associated with a volume of water for the water control device during the device operation; determining whether the water operation value is outside of a defined threshold associated with the device operation; upon a determination that the water operation value is outside of the defined threshold, adjusting an operational parameter associated with the water control device during the device operation to enable the water control device to be effectively operated.

According to a second aspect of the present disclosure, there is provided a building facility water management system for controlling at least one operational parameter associated with a volume of water used by a water control device during a device operation of the water control device in a building facility, the system comprising at least one water control device and at least one controller, wherein the controller is arranged to: obtain a water operation value associated with a volume of water for the water control device during the device operation; determine whether the water operation value is outside of a defined threshold associated with the device operation; upon a determination that the water operation value is outside of the defined threshold, adjust an operational parameter associated with the water control device during the device operation to enable the water control device to be effectively operated.

Other aspects are also disclosed.

### BRIEF DESCRIPTION OF THE DRAWINGS

At least one embodiment of the present invention will now be described with reference to the drawings and appendices, in which:

FIGS. 1A and 1B form a schematic block diagram of a general-purpose computer system upon which arrangements described can be practiced;

FIGS. 2A and 2B collectively form a schematic block diagram representation of an embedded electronic device upon which described arrangements can be practised;

FIGS. 3A to 3F show example network configurations upon which describe arrangements can be practised;

FIG. 4 shows an example water control device schematic diagram in accordance with a described embodiment;

FIG. 5 shows a controller of a water control device in accordance with a described embodiment;

FIGS. 6A and 6B show examples of how a toilet flush operation may be controlled in accordance with a described embodiment;

FIGS. 7A and 7B show examples of how a toilet cleanse operation may be controlled in accordance with a described embodiment;

FIG. 8 shows an example of a flow rate profile in accordance with the herein disclosure;

FIG. 9 shows an example of a control method in accordance with the herein disclosure.

### DETAILED DESCRIPTION INCLUDING BEST MODE

A building facility water management system for controlling at least one operational parameter associated with a volume of water used by a water control device during a device operation in a building facility is now described along with an associated method. The system has at least one water control device and at least one controller.

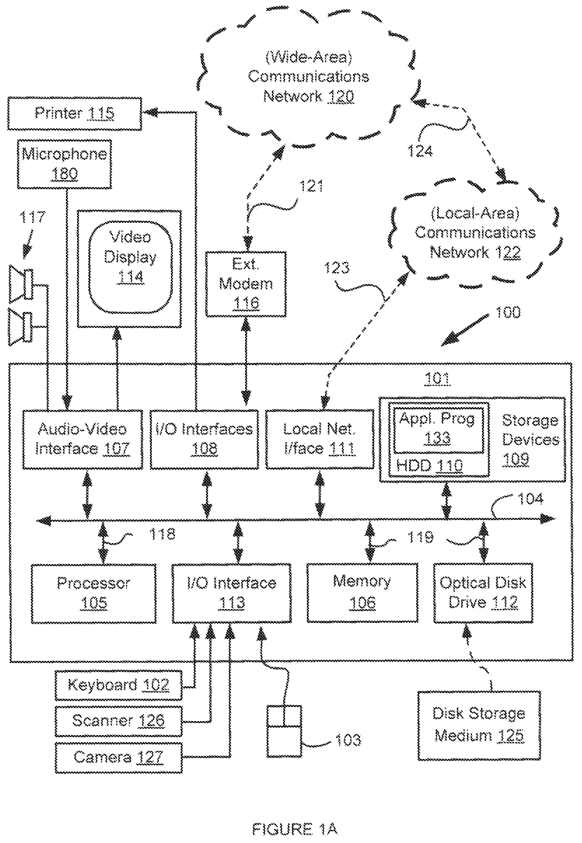

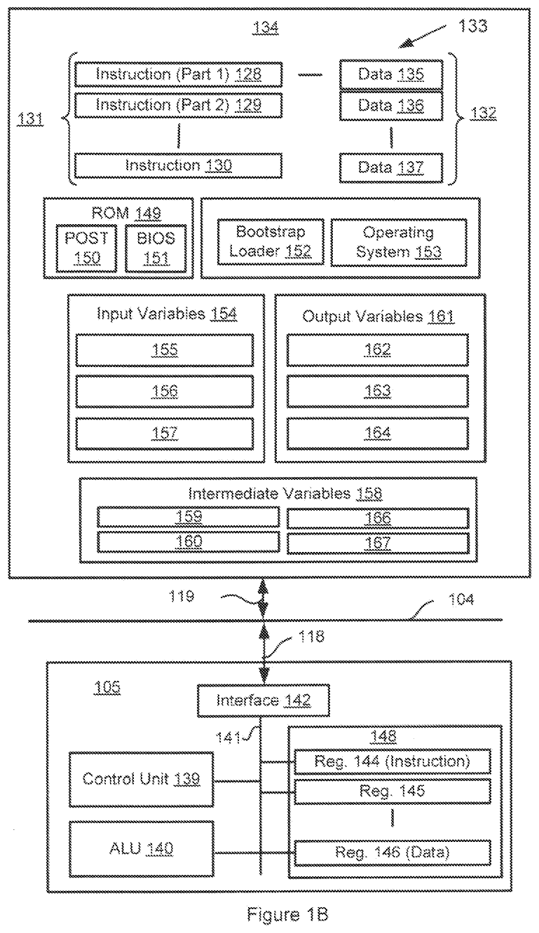

FIGS. 1A and 1B depict a general-purpose computer system 100, upon which various arrangements described herein may be practiced.

As seen in FIG. 1A, the typical computer system 100 includes: a computer module 101; input devices such as a keyboard 102, a mouse pointer device 103, a scanner 126, a camera 127, and a microphone 180; and output devices including a printer 115, a display device 114 and loudspeakers 117. Further, one or more water control devices as described herein may be connected via the I/O Interface 113. Further, one or more electronic devices as described herein may be connected via the I/O Interface 113. Further, a building management system may be connected via the I/O Interface 113. Further, one or more water control devices as described herein may be connected via the I/O Interface 113. Further, one or more intermediate processing devices may be connected via the I/O interface 113. Further an external Modulator-Demodulator (Modem) transceiver device 116 may be used by the computer module 101 for communicating to and from a communications network 120 via a connection 121. The communications network 120 may be a wide-area network (WAN), such as the Internet, a cellular telecommunications network, or a private WAN. Where the connection 121 is a telephone line, the modem 116 may be a traditional “dial-up” modem. Alternatively, where the connection 121 is a high capacity (e.g., cable) connection, the modem 116 may be a broadband modem. A wireless modem may also be used for wireless connection to the communications network 120.

The computer module 101 typically includes at least one processor unit 105, and a memory unit 106. For example, the memory unit 106 may have semiconductor random access memory (RAM) and semiconductor read only memory (ROM). The computer module 101 also includes an number of input/output (I/O) interfaces including: an audio-video interface 107 that couples to the video display 114, loudspeakers 117 and microphone 180; an I/O interface 113 that couples to the keyboard 102, mouse 103, scanner 126, camera 127 and optionally a joystick, touchscreen, voice recognition system or other human interface device (not illustrated); and an interface 108 for the external modem 116 and printer 115. In some implementations, the modem 116 may be incorporated within the computer module 101, for example within the interface 108. The computer module 101 also has a local network interface 111, which permits coupling of the computer system 100 via a connection 123 to a local-area communications network 122, known as a Local Area Network (LAN). As illustrated in FIG. 1A, the local communications network 122 may also couple to the wide network 120 via a connection 124, which would typically include a so-called “firewall” device or device of similar functionality. The local network interface 111 may comprise an Ethernet circuit card, a Bluetooth® wireless arrangement or an IEEE 802.11 wireless arrangement; however, numerous other types of interfaces may be practiced for the interface 111.

The local communications network 122 and/or the wide area communications network 120 may communicate with one or more controllers of water control devices as described herein. Further, the local communications network 122 and/or the wide area communications network 120 may communicate with other computing systems 100, electronic devices 201 (described below), Building Management Systems (BMS) etc.

The I/O interfaces 108 and 113 may afford either or both of serial and parallel connectivity, the former typically being implemented according to the Universal Serial Bus (USB) standards and having corresponding USB connectors (not illustrated). Storage devices 109 are provided and typically include a hard disk drive (HDD) 110. Other storage devices such as a floppy disk drive and a magnetic tape drive (not illustrated) may also be used. An optical disk drive 112 is typically provided to act as a non-volatile source of data. Portable memory devices, such optical disks (e.g., CD-ROM, DVD, Blu-ray Disc™), USB-RAM, portable, external hard drives, and floppy disks, for example, may be used as appropriate sources of data to the computer system 100.

The components 105 to 113 of the computer module 101 typically communicate via an interconnected bus 104 and in a manner that results in a conventional mode of operation of the computer system 100 known to those in the relevant art. For example, the processor 105 is coupled to the system bus 104 using a connection 118. Likewise, the memory 106 and optical disk drive 112 are coupled to the system bus 104 by connections 119. Examples of computers on which the described arrangements can be practised include IBM-PC's and compatibles, Apple Mac™ or a like computer systems.

The herein described computer may be, for example, configured as a server connected to the Internet and arranged to receive data in the form of instructions and information from other computers, electronic devices and water control devices connected to the server via the Internet. For example, the server may be connected to a local area network (LAN) or a wide area network (WAN). Access to the server may be by direct connection via the Internet or via other networks, such as LANs and WANs. The server may be configured to perform one or more of the various methods described herein for controlling one or more water control devices.

The herein described computer may be, for example, a building management computer forming part of a building management system (BMS) for controlling operations of a building. The building management system may form part of or be in communication with the building facility water management system described herein. The building management computer may communicate with the building management system, the building facility water management system and their components using any suitable communication protocols. The building management computer may be configured to perform one or more of the various building facility water management methods described herein for controlling one or more water control devices.

The building management system (BMS) may use standard BMS protocols such as BACnet, LON etc to communicate with other devices or components in the building facility water management system.

The herein described computer may be, for example, a personal computer or laptop forming part of a building management system for controlling operations of a building. The building management system may form part of or be in communication with the building facility water management system described herein. The personal computer or laptop may communicate with the building management system, the building facility water management system and their components using any suitable communication protocols. The personal computer or laptop may be configured to perform one or more of the various building facility water management methods described herein for controlling one or more water control devices.

One or more of the methods as described herein may be implemented using the computer system 100 wherein the processes described herein, may be implemented as one or more software application programs (“software”) 133 executable within the computer system 100. For example, the steps of these processes may be effected by instructions 131 (see FIG. 1B) in the software 133 that are carried out within the computer system 100. The software instructions 131 may be formed as one or more code modules, each for performing one or more particular tasks. The software may also be divided into two separate parts, in which a first part and the corresponding code modules performs the herein described methods and a second part and the corresponding code modules manage a user interface between the first part and the user.

The software may be stored in a computer readable medium, including the storage devices described below, for example. The software is loaded into the computer system 100 from the computer readable medium, and then executed by the computer system 100. A computer readable medium having such software or computer program recorded on the computer readable medium is a computer program product. The use of the software in the computer system 100 preferably effects an advantageous apparatus or system for managing water control devices. Further, the software may also be used to implement an artificial intelligence (AI) and/or machine learning (ML) system to perform the methods for managing water control devices as described herein.

The software 133 is typically stored in the HDD 110 or the memory 106. The software is loaded into the computer system 100 from a computer readable medium and executed by the computer system 100. Thus, for example, the software 133 may be stored on an optically readable disk storage medium (e.g., CD-ROM) 125 that is read by the optical disk drive 112. A computer readable medium having such software or computer program recorded on it is a computer program product. The use of the computer program product in the computer system 100 preferably effects an apparatus for managing water control devices.

In some instances, the software 133 may be supplied to the user encoded on one or more CD-ROMs 125 and read via the corresponding drive 112, or alternatively may be read by the user from the networks 120 or 122. Still further, the software can also be loaded into the computer system 100 from other computer readable media. Computer readable storage media refers to any non-transitory tangible storage medium that provides recorded instructions and/or data to the computer system 100 for execution and/or processing. Examples of such storage media include floppy disks, magnetic tape, CD-ROM, DVD, Blu-ray™ Disc, a hard disk drive, a ROM or integrated circuit, USB memory, a magneto-optical disk, or a computer readable card such as a PCMCIA card and the like, whether or not such devices are internal or external of the computer module 101. Examples of transitory or non-tangible computer readable transmission media that may also participate in the provision of software, application programs, instructions and/or data to the computer module 101 include radio or infra-red transmission channels as well as a network connection to another computer or networked device, and the Internet or Intranets including e-mail transmissions and information recorded on websites and the like.

The second part of the software 133 and the corresponding code modules mentioned above may be executed to implement one or more graphical user interfaces (GUIs) to be rendered or otherwise represented upon the display 114. Through manipulation of typically the keyboard 102 and the mouse 103, a user of the computer system 100 and the application may manipulate the interface in a functionally adaptable manner to provide controlling commands and/or input to the applications associated with the GUI(s). Other forms of functionally adaptable user interfaces may also be implemented, such as an audio interface utilizing speech prompts output via the loudspeakers 117 and user voice commands input via the microphone 180.

FIG. 1B is a detailed schematic block diagram of the processor 105 and a “memory” 134. The memory 134 represents a logical aggregation of all the memory modules (including the HDD 109 and semiconductor memory 106) that can be accessed by the computer module 101 in FIG. 1A.

When the computer module 101 is initially powered up, a power-on self-test (POST) program 150 executes. The POST program 150 is typically stored in a ROM 149 of the semiconductor memory 106 of FIG. 1A. A hardware device such as the ROM 149 storing software is sometimes referred to as firmware. The POST program 150 examines hardware within the computer module 101 to ensure proper functioning and typically checks the processor 105, the memory 134 (109, 106), and a basic input-output systems software (BIOS) module 151, also typically stored in the ROM 149, for correct operation. Once the POST program 150 has run successfully, the BIOS 151 activates the hard disk drive 110 of FIG. 1A. Activation of the hard disk drive 110 causes a bootstrap loader program 152 that is resident on the hard disk drive 110 to execute via the processor 105. This loads an operating system 153 into the RAM memory 106, upon which the operating system 153 commences operation. The operating system 153 is a system level application, executable by the processor 105, to fulfil various high level functions, including processor management, memory management, device management, storage management, software application interface, and generic user interface.

The operating system 153 manages the memory 134 (109, 106) to ensure that each process or application running on the computer module 101 has sufficient memory in which to execute without colliding with memory allocated to another process. Furthermore, the different types of memory available in the system 100 of FIG. 1A must be used properly so that each process can run effectively. Accordingly, the aggregated memory 134 is not intended to illustrate how particular segments of memory are allocated (unless otherwise stated), but rather to provide a general view of the memory accessible by the computer system 100 and how such is used.

As shown in FIG. 1B, the processor 105 includes a number of functional modules including a control unit 139, an arithmetic logic unit (ALU) 140, and a local or internal memory 148, sometimes called a cache memory. The cache memory 148 typically includes a number of storage registers 144-146 in a register section. One or more internal busses 141 functionally interconnect these functional modules. The processor 105 typically also has one or more interfaces 142 for communicating with external devices via the system bus 104, using a connection 118. The memory 134 is coupled to the bus 104 using a connection 119.

The software 133 includes a sequence of instructions 131 that may include conditional branch and loop instructions. The software 133 may also include data 132 which is used in execution of the software 133. The instructions 131 and the data 132 are stored in memory locations 128, 129, 130 and 135, 136, 137, respectively. Depending upon the relative size of the instructions 131 and the memory locations 128-130, a particular instruction may be stored in a single memory location as depicted by the instruction shown in the memory location 130. Alternately, an instruction may be segmented into a number of parts each of which is stored in a separate memory location, as depicted by the instruction segments shown in the memory locations 128 and 129.

In general, the processor 105 is given a set of instructions which are executed therein. The processor 1105 waits for a subsequent input, to which the processor 105 reacts to by executing another set of instructions. Each input may be provided from one or more of a number of sources, including data generated by one or more of the input devices 102, 103, data received from an external source across one of the networks 120, 102, data retrieved from one of the storage devices 106, 109 or data retrieved from a storage medium 125 inserted into the corresponding reader 112, all depicted in FIG. 1A. The execution of a set of the instructions may in some cases result in output of data. Execution may also involve storing data or variables to the memory 134.

The disclosed water management arrangements use input variables 154, which are stored in the memory 134 in corresponding memory locations 155, 156, 157. The water management arrangements produce output variables 161, which are stored in the memory 134 in corresponding memory locations 162, 163, 164. Intermediate variables 158 may be stored in memory locations 159, 160, 166 and 167.

Referring to the processor 105 of FIG. 1B, the registers 144, 145, 146, the arithmetic logic unit (ALU) 140, and the control unit 139 work together to perform sequences of micro-operations needed to perform “fetch, decode, and execute” cycles for every instruction in the instruction set making up the software 133. Each fetch, decode, and execute cycle comprises:

a fetch operation, which fetches or reads an instruction 131 from a memory location 128, 129, 130;

a decode operation in which the control unit 139 determines which instruction has been fetched; and

an execute operation in which the control unit 139 and/or the ALU 140 execute the instruction.

Thereafter, a further fetch, decode, and execute cycle for the next instruction may be executed. Similarly, a store cycle may be performed by which the control unit 139 stores or writes a value to a memory location 132.

Each step or sub-process in the processes described herein may be associated with one or more segments of the software 133 and is performed by the register section 144, 145, 147, the ALU 140, and the control unit 139 in the processor 105 working together to perform the fetch, decode, and execute cycles for every instruction in the instruction set for the noted segments of the software 133.

The methods of water management may alternatively be implemented in dedicated hardware such as one or more integrated circuits performing the functions or sub functions of water management. Such dedicated hardware may include graphic processors, digital signal processors, or one or more microprocessors and associated memories.

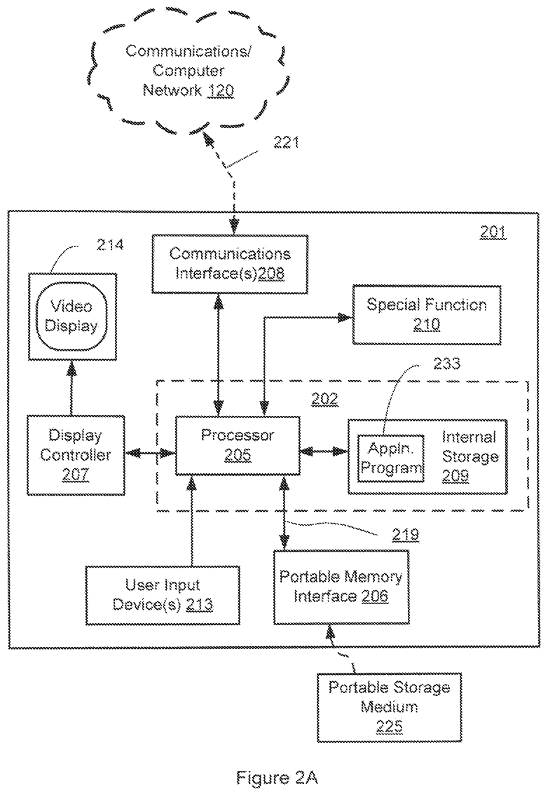

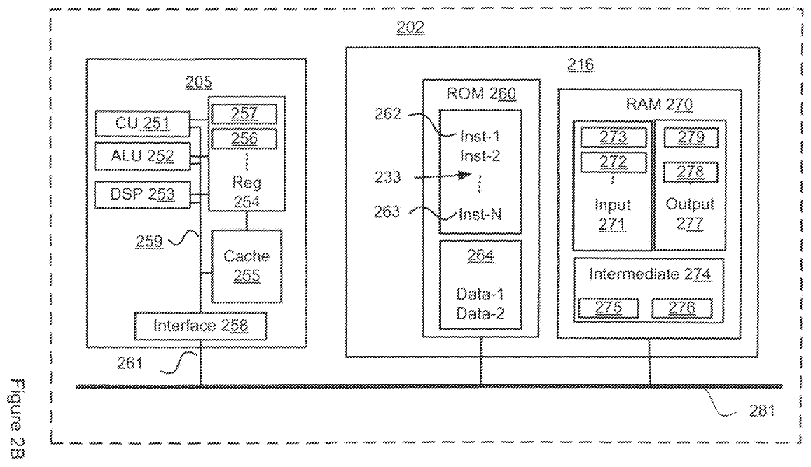

FIGS. 2A and 2B collectively form a schematic block diagram of a general-purpose electronic device 201 including embedded components, upon which the water management methods described herein are practiced. The embedded electronic device 201 may be, for example, a mobile phone, a tablet device, a smart watch, personal digital assistant type device or any other embedded electronic device, in which processing resources may be limited. Nevertheless, the methods described herein may also be performed on higher-level devices such as desktop computers, server computers, and other such devices with significantly larger processing resources.

As seen in FIG. 2A, the electronic device 201 comprises an embedded controller 202. Accordingly, the electronic device 201 may be referred to as an “embedded device.” In the present example, the controller 202 has a processing unit (or processor) 205 which is bi-directionally coupled to an internal storage module 209. The storage module 209 may be formed from non-volatile semiconductor read only memory (ROM) 260 and semiconductor random access memory (RAM) 270, as seen in FIG. 2B. The RAM 270 may be volatile, non-volatile or a combination of volatile and non-volatile memory.

The electronic device 201 includes a display controller 207, which is connected to a video display 214, such as a liquid crystal display (LCD) panel or the like. The display controller 207 is configured for displaying graphical images on the video display 214 in accordance with instructions received from the embedded controller 202, to which the display controller 207 is connected.

The electronic device 201 also includes user input devices 213 which are typically formed by keys, a keypad or like controls. In some implementations, the user input devices 213 may include a touch sensitive panel physically associated with the display 214 to collectively form a touchscreen. Such a touchscreen may thus operate as one form of graphical user interface (GUI) as opposed to a prompt or menu driven GUI typically used with keypad-display combinations. Other forms of user input devices may also be used, such as a microphone (not illustrated) for voice commands or a joystick/thumb wheel (not illustrated) for ease of navigation about menus.

As seen in FIG. 2A, the electronic device 201 also comprises a portable memory interface 206, which is coupled to the processor 205 via a connection 219. The portable memory interface 206 allows a complementary portable memory device 225 to be coupled to the electronic device 201 to act as a source or destination of data or to supplement the internal storage module 209. Examples of such interfaces permit coupling with portable memory devices such as Universal Serial Bus (USB) memory devices, Secure Digital (SD) cards, Personal Computer Memory Card International Association (PCMIA) cards, optical disks and magnetic disks.

The electronic device 201 also has a communications interface 208 to permit coupling of the device 201 to a computer or communications network 220 via a connection 221. For example, one or more water control devices as described herein may be connected to the electronic device via the communications interface 208. Further, one or more electronic devices as described herein may be connected to the electronic device via the communications interface 208. Further, a building management system may be connected to the electronic device via the communications interface 208. Further, one or more water control devices as described herein may be connected to the electronic device via the communications interface 208. Further, one or more intermediate processing devices may be connected to the electronic device via the communications interface 208.

The connection 221 may be wired or wireless. For example, the connection 221 may be radio frequency or optical. An example of a wired connection includes Ethernet. Further, an example of wireless connection includes Bluetooth™ type local interconnection, Wi-Fi (including protocols based on the standards of the IEEE 802.11 family), Infrared Data Association (IrDa) and the like. The electronic device 201 may communicate with one or more water control devices.

Typically, the electronic device 201 is configured to perform some special function. The embedded controller 202, possibly in conjunction with further special function components 210, is provided to perform that special function. The special function components 210 are connected to the embedded controller 202. As an example, the device 201 may be a mobile telephone handset. In this instance, the components 210 may represent those components required for communications in a cellular telephone environment. Alternatively, the components 210 may be an artificial intelligence (AI) and/or machine learning (ML) module for performing the methods for managing water control devices as described herein

Various methods associated with water control devices described hereinafter may be implemented using the embedded controller 202, where the processes described herein may be implemented as one or more software application programs (“software”) 233 executable within the embedded controller 202. The electronic device 201 of FIG. 2A implements the described methods. In particular, with reference to FIG. 2B, the steps of the herein described methods are effected by instructions in the software 233 that are carried out within the controller 202. The software instructions may be formed as one or more code modules, each for performing one or more particular tasks. The software may also be divided into two separate parts, in which a first part and the corresponding code modules performs the described methods and a second part and the corresponding code modules manage a user interface between the first part and the user. Further, the software 233 may be used to implement an artificial intelligence (AI) and/or machine learning (ML) system to perform the methods for managing water control devices as described herein.

The software 233 of the embedded controller 202 is typically stored in the non-volatile ROM 260 of the internal storage module 209. The software 233 stored in the ROM 260 can be updated when required from a computer readable medium. The software 233 can be loaded into and executed by the processor 205. In some instances, the processor 205 may execute software instructions that are located in RAM 270. Software instructions may be loaded into the RAM 270 by the processor 205 initiating a copy of one or more code modules from ROM 260 into RAM 270. Alternatively, the software instructions of one or more code modules may be pre-installed in a non-volatile region of RAM 270 by a manufacturer. After one or more code modules have been located in RAM 270, the processor 205 may execute software instructions of the one or more code modules.

The software 233 is typically pre-installed and stored in the ROM 260 by a manufacturer, prior to distribution of the electronic device 201. However, in some instances, the software 233 may be supplied to the user encoded on one or more CD-ROM (not shown) and read via the portable memory interface 206 of FIG. 2A prior to storage in the internal storage module 209 or in the portable memory 225. In another alternative, the software 233 may be read by the processor 205 from the network 220, or loaded into the controller 202 or the portable storage medium 225 from other computer readable media. Computer readable storage media refers to any non-transitory tangible storage medium that participates in providing instructions and/or data to the controller 202 for execution and/or processing. Examples of such storage media include floppy disks, magnetic tape, CD-ROM, a hard disk drive, a ROM or integrated circuit, USB memory, a magneto-optical disk, flash memory, or a computer readable card such as a PCMCIA card and the like, whether or not such devices are internal or external of the device 201. Examples of transitory or non-tangible computer readable transmission media that may also participate in the provision of software, application programs, instructions and/or data to the device 201 include radio or infra-red transmission channels as well as a network connection to another computer or networked device, and the Internet or Intranets including e-mail transmissions and information recorded on Websites and the like. A computer readable medium having such software or computer program recorded on it is a computer program product.

The second part of the software 233 and the corresponding code modules mentioned above may be executed to implement one or more graphical user interfaces (GUIs) to be rendered or otherwise represented upon the display 214 of FIG. 2A. Through manipulation of the user input device 213 (e.g., the keypad), a user of the device 201 and the software 233 may manipulate the interface in a functionally adaptable manner to provide controlling commands and/or input to the applications associated with the GUI(s). Other forms of functionally adaptable user interfaces may also be implemented, such as an audio interface utilizing speech prompts output via loudspeakers (not illustrated) and user voice commands input via the microphone (not illustrated).

FIG. 2B illustrates in detail the embedded controller 202 having the processor 205 for executing the software 233 and the internal storage 209. The internal storage 209 comprises read only memory (ROM) 260 and random access memory (RAM) 270. The processor 205 is able to execute the software 233 stored in one or both of the connected memories 260 and 270. When the electronic device 201 is initially powered up, a system program resident in the ROM 260 is executed. The software 233 permanently stored in the ROM 260 is sometimes referred to as “firmware”. Execution of the firmware by the processor 205 may fulfil various functions, including processor management, memory management, device management, storage management and user interface.

The processor 205 typically includes a number of functional modules including a control unit (CU) 251, an arithmetic logic unit (ALU) 252, a digital signal processor (DSP) 2153 and a local or internal memory comprising a set of registers 254 which typically contain atomic data elements 256, 257, along with internal buffer or cache memory 255. One or more internal buses 259 interconnect these functional modules. The processor 205 typically also has one or more interfaces 258 for communicating with external devices via system bus 281, using a connection 261.

The software 233 includes a sequence of instructions 262 through 263 that may include conditional branch and loop instructions. The software 233 may also include data, which is used in execution of the software 233. This data may be stored as part of the instruction or in a separate location 264 within the ROM 260 or RAM 270.

In general, the processor 205 is given a set of instructions, which are executed therein. This set of instructions may be organised into blocks, which perform specific tasks or handle specific events that occur in the electronic device 201. Typically, the software 233 waits for events and subsequently executes the block of code associated with that event. Events may be triggered in response to input from a user, via the user input devices 213 of FIG. 2A, as detected by the processor 205. Events may also be triggered in response to other sensors and interfaces in the electronic device 201.

The execution of a set of the instructions may require numeric variables to be read and modified. Such numeric variables are stored in the RAM 270. The disclosed method uses input variables 271 that are stored in known locations 272, 273 in the memory 270. The input variables 271 are processed to produce output variables 277 that are stored in known locations 278, 279 in the memory 270. Intermediate variables 274 may be stored in additional memory locations in locations 275, 276 of the memory 270. Alternatively, some intermediate variables may only exist in the registers 254 of the processor 205.

The execution of a sequence of instructions is achieved in the processor 205 by repeated application of a fetch-execute cycle. The control unit 251 of the processor 205 maintains a register called the program counter, which contains the address in ROM 260 or RAM 270 of the next instruction to be executed. At the start of the fetch execute cycle, the contents of the memory address indexed by the program counter is loaded into the control unit 251. The instruction thus loaded controls the subsequent operation of the processor 205, causing for example, data to be loaded from ROM memory 260 into processor registers 254, the contents of a register to be arithmetically combined with the contents of another register, the contents of a register to be written to the location stored in another register and so on. At the end of the fetch execute cycle the program counter is updated to point to the next instruction in the system program code. Depending on the instruction just executed this may involve incrementing the address contained in the program counter or loading the program counter with a new address in order to achieve a branch operation.

Each step or sub-process in the processes of the methods described below is associated with one or more segments of the software 233, and is performed by repeated execution of a fetch-execute cycle in the processor 205 or similar programmatic operation of other independent processor blocks in the electronic device 201.

Various examples of water control device operation and control will now be described.

It will be understood that where examples are described in which a particular type of water control device is operated that other alternative types of water control device may also be operated in a similar manner.

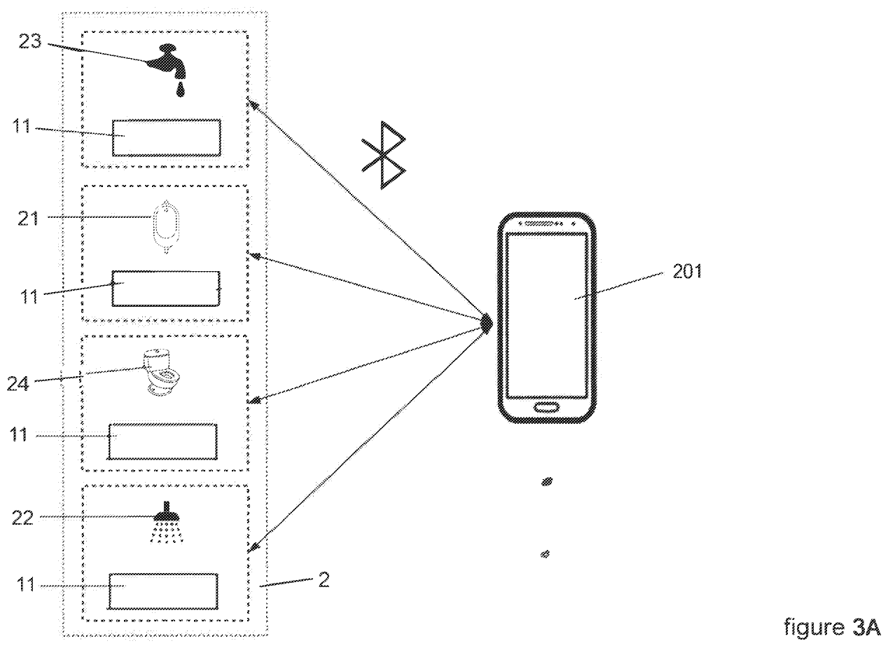

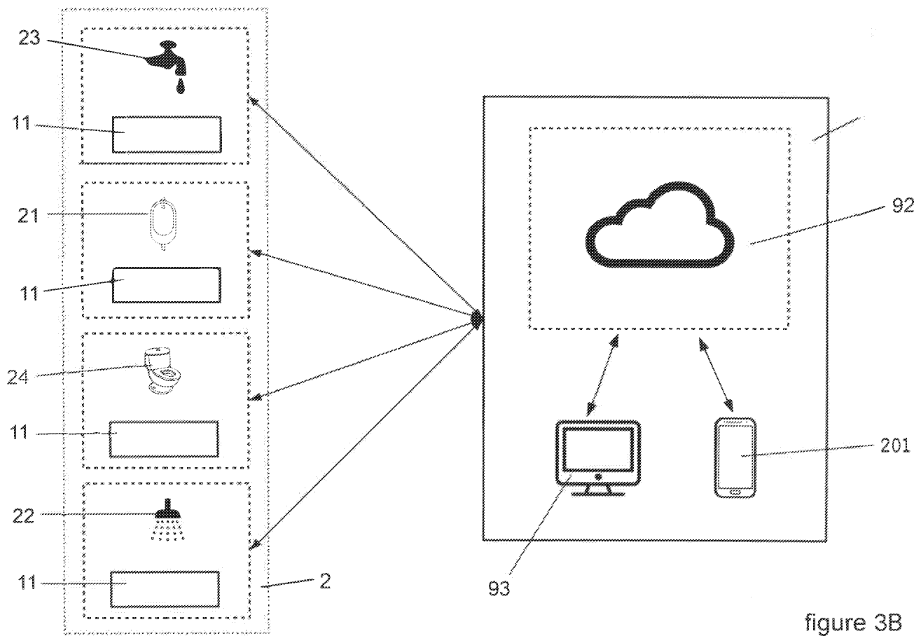

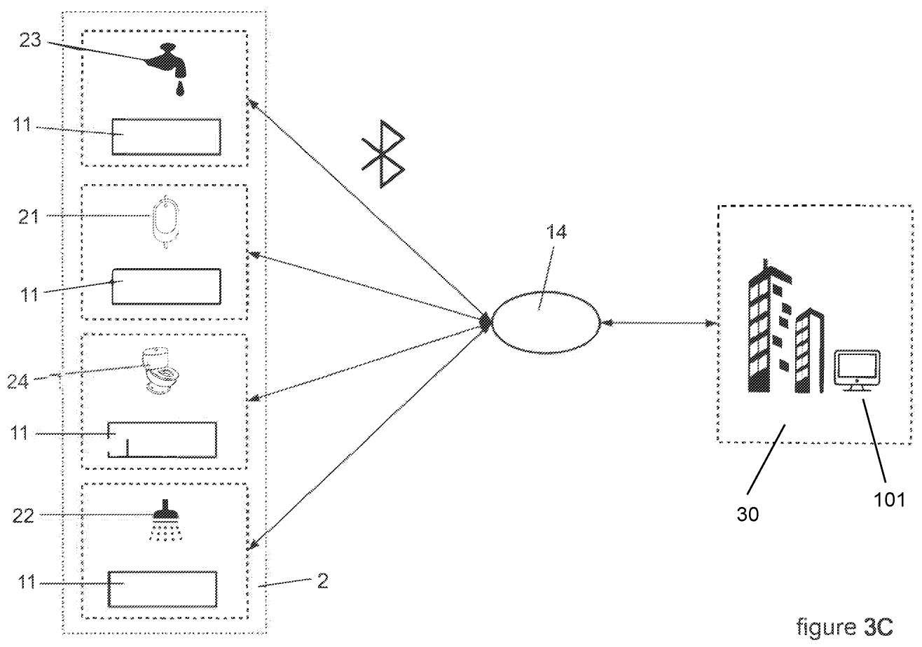

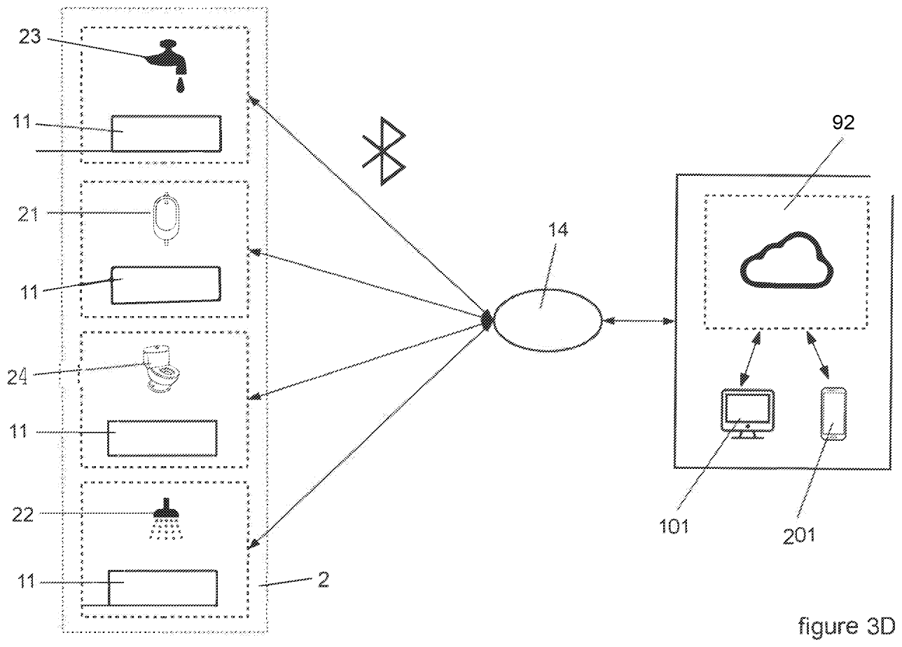

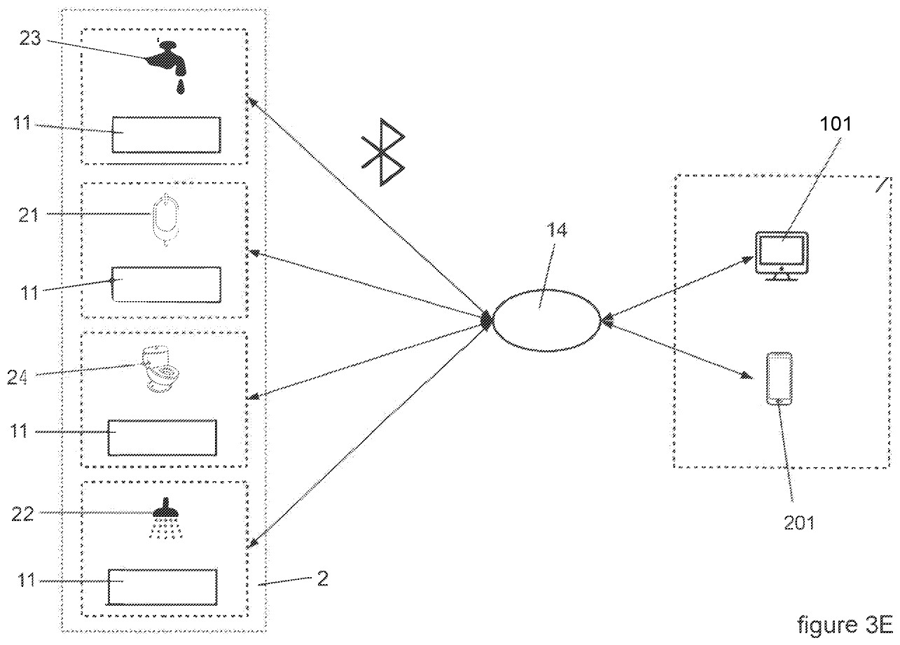

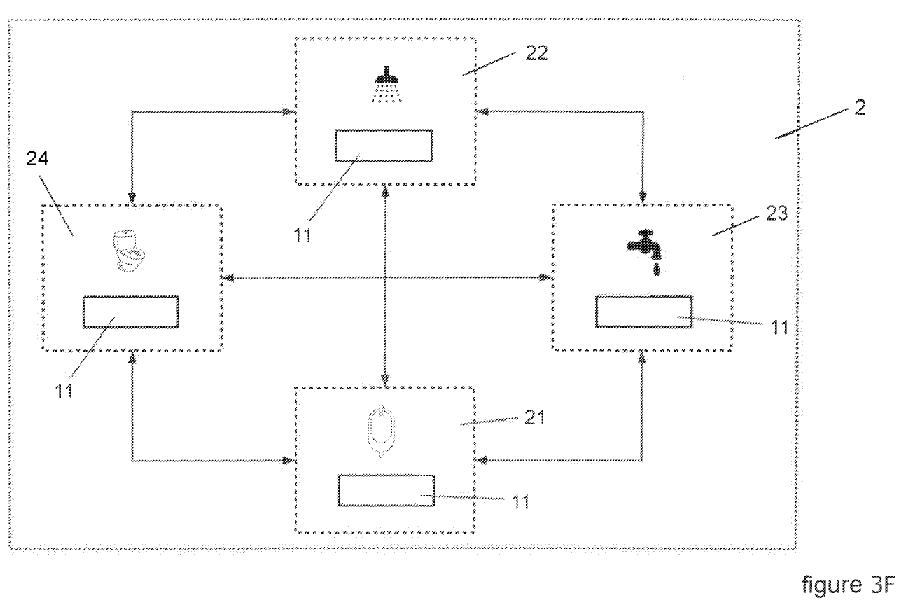

FIGS. 3A to 3F show several different example network configurations of water control devices and connected devices and computers in which the herein described methods may be applied.

In FIG. 3A, water control devices are shown in a sanitary facility 2. The water control devices include, for example, a urinal 21, a shower 22, a tap (or faucet) 23 and a toilet 24. Each of the water control devices has an associated water control device controller 11. The controller 11 of each water control device can communicate using Bluetooth to an electronic device 201, as described above with reference to FIGS. 2A & 2B. For example, the electronic device may be a mobile telephone handset, tablet device or other small computing device.

It will be understood that alternative communication means other than Bluetooth may be used such as IrDA (Infrared data association protocol), local Wi-Fi communications etc.

FIG. 3A shows a network configuration in which each controller of a water control device communicates separately via the Internet 92 to a computing device 101 as described above with reference to FIGS. 1A & 1B and/or an electronic device 201 as described above with reference to FIGS. 2A & 2B. It will also be understood that each controller of a water control device may communicate separately with multiple electronic devices as indicated by the dots in FIG. 3A.

For example, the electronic device may be a mobile telephone handset, tablet device or other small computing device. Also, for example, the computing device may be a personal computer, a laptop, a server, a building management system computer etc.

In FIG. 3B, water control devices are shown in a sanitary facility 2. The water control devices include, for example, a urinal 21, a shower 22, a tap (or faucet) 23 and a toilet 24. Each of the water control devices has an associated water control device controller 11. The controller 11 of each water control device can communicate using any suitable Internet connection such as via a Wi-Fi modem, or a cellular data connection, such as 4G or 5G. An intermediate processing device (not shown) may be provided such as a central gateway device, modem and/or router to enable one or more of the water control devices to communicate with the Internet.

It will be understood that intermediate communication protocols may be used such as Bluetooth and IrDA (Infrared data association protocol) etc. to enable the Internet connection.

FIG. 3B shows a network configuration in which each controller of a water control device communicates separately to the computing device 101 and/or the electronic device 201. It will also be understood that each controller of a water control device may communicate separately with multiple computing devices and/or multiple electronic devices.

For example, the electronic device may be a mobile telephone handset, tablet device or other small computing device. Also, for example, the computing device may be a personal computer, a laptop, a server, a building management system computer etc.

In FIG. 3C, water control devices are shown in a sanitary facility 2. The water control devices include, for example, a urinal 21, a shower 22, a tap (or faucet) 23 and a toilet 24. The controller 11 of each water control device can communicate using Bluetooth to an intermediate processing device 14. The intermediate processing device may be, for example, a central gateway device, to enable one or more of the water control devices to communicate via the intermediate processing device to a Building Management System (BMS) 30. For example, the central gateway device may communicate directly with the BMS using standard BMS protocols such as BACnet, LON etc to communicate. The BMS may include one or more computing devices 101 and/or electronic devices (not shown) to enable the BMS to communicate with the water control devices via the intermediate processing device.

For example, the electronic device may be a mobile telephone handset, tablet device or other small computing device. Also, for example, the computing device may be a personal computer, a laptop, a server, a building management system computer etc.

It will be understood that alternative communication means other than Bluetooth may be used such as IrDA (Infrared data association protocol), local Wi-Fi communications etc. to enable the water control devices to communicate with the BMS, and vice versa.

FIG. 3C shows a network configuration in which each controller of a water control device communicates separately via a single intermediate processing device to the BMS. It will also be understood that each controller of a water control device may communicate separately with its own intermediate processing device.

In FIG. 3D, water control devices are shown in a sanitary facility 2. The water control devices include, for example, a urinal 21, a shower 22, a tap (or faucet) 23 and a toilet 24. The controller 11 of each water control device can communicate using Bluetooth to an intermediate processing device 14. The intermediate processing device may be, for example, a central gateway device, a modem and/or router to enable one or more of the water control devices to communicate via the intermediate processing device to a Building Management System (BMS) 30. In this configuration, the intermediate processing device communicates with the BMS via the Internet. The BMS may include one or more computing devices 101 and/or electronic devices (not shown) to enable the BMS to communicate with the water control devices via the intermediate processing device.

For example, the electronic device may be a mobile telephone handset, tablet device or other small computing device. Also, for example, the computing device may be a personal computer, a laptop, a server, a building management system computer etc.

It will be understood that alternative communication means other than Bluetooth may be used such as IrDA (Infrared data association protocol), local Wi-Fi communications etc. to enable the water control devices to communicate with the BMS, and vice versa.

FIG. 3D shows a network configuration in which each controller of a water control device communicates separately via a single intermediate processing device to the BMS. It will also be understood that each controller of a water control device may communicate separately with its own intermediate processing device.

In FIG. 3E, water control devices are shown in a sanitary facility 2. The water control devices include, for example, a urinal 21, a shower 22, a tap (or faucet) 23 and a toilet 24. The controller 11 of each water control device can communicate using Bluetooth to an intermediate processing device 14. The intermediate processing device may be, for example, a central gateway device, to enable one or more of the water control devices to communicate via the intermediate processing device to a one or more computing devices 101 and/or electronic devices 201.

For example, the electronic device may be a mobile telephone handset, tablet device or other small computing device. Also, for example, the computing device may be a personal computer, a laptop, a server, a building management system computer etc.

It will be understood that alternative communication means other than Bluetooth may be used such as IrDA (Infrared data association protocol), local Wi-Fi communications etc. to enable the water control devices to communicate with the intermediate processing device.

It will be understood that any suitable communication protocols may be used to enable the intermediate processing device to communicate with the one or more computing devices 101 and/or electronic devices 201, such as IrDA (Infrared data association protocol, Bluetooth, Wi-Fi, cellular data etc.

FIG. 3F shows a network configuration in which each controller 11 of a water control device communicates with other controllers 11 in other water control devices. The network is configured as a mesh network. In this example configuration, data may be shared between water control devices in the mesh network. A first controller in a first water control device may be enabled to control/monitor the first water control device. Alternatively, the first controller in the first water control device may be enabled to control/monitor one or more other water control devices based on data received from one or more other controllers. Also, a controller in a first water control device may be enabled to control/monitor the first water control device and/or one or more other water control devices. Further, data received at a first controller from a first water control device may be used to control/monitor the first water control device and/or one or more other water control devices.

In FIG. 3F, water control devices are shown in a sanitary facility 2. The water control devices include, for example, a urinal 21, a shower 22, a tap (or faucet) 23 and a toilet 24, as examples. The controller 11 of each water control device can communicate using Bluetooth, for example, with one or more controllers of other water control devices.

Each of the water control devices may connect and disconnect to the mesh network as it is plugged in and unplugged from the network. This is termed “plug n play’ (PnP) and so each water control device may be a PnP water control device. This enables PnP water control devices to be added and removed from the mesh network with ease. This may also enable PnP water control devices to communicate with each other. This may also enable PnP water control devices to be organised in a hierarchical structure that may be taken into account and used when adjusting operational parameters of water control devices as described herein.

It will be understood that alternative communication means other than Bluetooth may be used such as IrDA (Infrared data association protocol), local Wi-Fi communications etc. to enable the controllers of the water control devices to communicate with each other.

The mesh network is in communication with one or more BMS, one or more computing device, one or more electronic device, one or more central gateway device, one or more intermediate processing device or any combination therefor using any suitable communication protocols.

For example, the electronic device may be a mobile telephone handset, tablet device or other small computing device. Also, for example, the computing device may be a personal computer, a laptop, a server, a building management system computer as part of the BMS etc.

It will be understood that configurations that are alternative to the ones shown in FIGS. 3A to 3F may be utilised. As an example, the configuration shown in FIGS. 3A and 3B may be combined. As another example, the configuration shown in FIGS. 3A and 3C may be combined. As another example, the configuration shown in FIGS. 3A and 3D may be combined. As another example, the configuration shown in FIGS. 3A and 3E may be combined. As another example, the configuration shown in FIGS. 3B and 3C may be combined. As another example, the configuration shown in FIGS. 3B and 3D may be combined. As another example, the configuration shown in FIGS. 3B and 3E may be combined. As another example, the configuration shown in FIGS. 3C and 3D may be combined. As another example, the configuration shown in FIGS. 3C and 3E may be combined. As another example, the configuration shown in FIGS. 3D and 3E may be combined.

Further, the mesh configuration shown in FIG. 3F may be used with any of the herein described configurations or combinations.

In each of the herein described configurations or combinations, one or more of the water control devices may communicate with one or more smart water meters (not shown) located in the sanitary facility and/or the building facility. The one or more smart meters may capture data, such as water operation values, associated with the water made available to one or more of the water control devices, water made available to one or more sanitary facilities, water made available to one or more particular areas in a building facility, water made available to one or more floors of a building facility, water made available to one or more building facilities etc. For example, the water operation values may be water volume usage values, water flow rate usage values, water pressure values, historical water usage values, historical pressure values etc.

In each of the herein described configurations or combinations, the communication between the controller 11 of the water control device (21-24) and the data receiving device (101, 201, 14, smart water meter etc.) may be bi-directional.

The controller 11 of the water control device (21-24) may transmit data associated with identifying the water control device, such as the location of the water control device, a device unique identification, a device name, a device product type identification, a device product identification, etc.

The controller 11 of a first water control device (21-24) may transmit data associated with, for example, operational functions, modes of operation, operational parameters, historical device operations, warnings, messages etc. that are associated with the first water control device or another different water control device that is in communication with the first water control device.

FIG. 4 shows an example water control device (21, 22, 23, 24) schematic diagram with a controller 11. An inlet water flow 401 and outlet water flow 403 is shown. An inlet water valve 405 is in fluid connection between the inlet water flow 401 and the water control device. In this example, the inlet water valve 405 communicates, via communication channel 407, one or more water operation values to the controller. In this example, the water operation value is an inlet water pressure value associated with the pressure of the water at the inlet to the water control device. The controller is arranged to determine whether the water operation value is outside of a defined threshold associated with the device operation. If the controller makes a determination that the water operation value is outside of the defined threshold, an operational parameter associated with the water control device during the device operation may be adjusted by the controller and communicated to the inlet water valve via communication channel 409. The adjusted operational parameter then enables the water control device to be effectively operated.

For example, if the water control device is a urinal 21, the volume of water required for a standard flush operation to be an effective standard flush operation may be defined as 0.8 litres. If the inlet water pressure value (water operation value) is below a defined inlet water pressure value threshold for providing the effective standard flush operation utilising 0.8 litres, then the controller may adjust an operational parameter such as, for example, the time the inlet water valve is open, or by regulating the inlet valve to open more or less in order to provide the volume of water associated with effectively operating the urinal.

Therefore, there is provided a building facility water management method for controlling at least one operational parameter associated with a volume of water used by a water control device during a device operation in a building facility. For example, the building facility may be office buildings, hotels, motels, resorts, warehouse facilities, storage facilities, shopping malls, airports etc.

The method used by the building facility water management system enables the controller to obtain a water operation value associated with a volume of water for the water control device during the device operation. The method also enables the controller to determine whether the water operation value is outside of a defined threshold associated with the device operation. If the controller makes a determination that the water operation value is outside of the defined threshold, the method then enables the controller to adjust an operational parameter associated with the water control device during the device operation to enable the water control device to be effectively operated.

In the example described above for the urinal in relation to FIG. 4, the water operation value is measured in real-time and so is a real-time water operation value. That is, the inlet water pressure value is measured in real time by the controller by obtaining an inlet water pressure value in real time from an inlet water pressure sensor. The inlet water pressure sensor may be a component in the inlet water valve 405 or may, alternatively, be located elsewhere within the water inlet to measure the inlet water pressure at another point in the water inlet system.

By using a real-time value, the adjustment of the operational parameter may be based on the current parameters associated with the device operation.

As an alternative, the water operation value may be based on a stored water operation value. That is, in the example of the urinal in relation to FIG. 4, one or more inlet water pressure values may have been stored from previous device operations over a period of time. The controller may obtain the stored inlet water pressure value from memory. For example, the controller may obtain the last stored water operation value. Alternatively, the controller may obtain an average, mean or median of two or more previously stored water operation values.

Example water operation values include one or more of an inlet water pressure at the water control device, a water supply pressure value associated with a water supply for the water control device, a water level of the volume of water associated with the device operation, an inlet flow rate associated with the device operation, an outlet flow rate associated with the device operation and a water volume associated with the device operation.

Further, the water operation value may have been obtained based on one or more previous device operations. For example, an average, mean, median, or other statistical calculation may be made based on one or more water operation values that were obtained from one or more previous device operations.

Further, the adjusting of the operational parameter may adjust the volume of water available to the water control device to complete the device operation and/or subsequent device operations. That is, there may be a single adjustment for multiple subsequent device operations. There may also be a single adjustment to complete the current device operation.

FIG. 5 shows an example of a controller 11 of a water control device.

The controller 11 has a microprocessor 501 that is in communication with an input/output (I/O) interface 503 that receives incoming signals 505 and transmits outgoing signals 507. The microprocessor also communicates with a memory 509 to enable incoming data to be stored and stored data to be retrieved and transmitted. The microprocessor also communicates with a communications interface 511 for communicating with one or more other water control devices, computer devices, electronic devices, smart water meters, intermediate processing devices, BMS etc. The controller 11 and its components are powered by a power system 513 that either has an external power inlet 515 or is powered by an internal power store (e.g. a battery).

The memory 509 may store one or more profiles and/or operation tables associated with one or more device operations associated with one or more water control devices.

The controller 11 in one water control device may communicate with controllers in one or more other water control devices. For example, a first controller may obtain data from a memory 509 in another controller, or a smart water meter.

The controller 11 may have an artificial intelligence (AI) and/or machine learning (ML) module 517 integrated therein. The AI/ML module communicates with the microprocessor 501 and memory 509.

The controller 11 in one water control device may communicate with an AI/ML module 517 in one or more other water control device, electronic device 201, computing system 100, building management system etc.

It will be understood that the AI/ML module may also be an AI/ML system that is separate to the controller 11 but in communication with the controller. For example, the AI/ML system may be at least part of a computer system or electronic device as described herein with reference to FIGS. 1A, 1B, 2A, 2B, where the computer system or electronic device is in communication with the controller 11 via any suitable communication means as described herein.

The AI/ML module or system may also communicate with one or more smart meters to obtain water operation values.

The AI/ML system or module may include an artificial neuronal net and/or an expert system.

The AI/ML system or module may be trained using supervised learning, where the AI/ML system is trained with pre-defined data.

The AI/ML system or module may be trained using un-supervised learning, where the AI/ML system is continuously learning based on the data that is received and transmitted over time during one or more device operations.

The AI/ML system or module may be trained using reinforcement learning, where the AI/ML system receives feedback and/or responses from one or more other controllers and/or water control devices in the building facility water management system. This training may be based on previous device operations that occurred successfully and/or unsuccessfully.

Any combination of the supervised, un-supervised, reinforcement learning processes may be carried out at any time either singularly or in combination by one or more of the controllers in communication with one or more AI/ML systems or modules.

The AI/ML system or module may operate initially in a start-up mode after which it starts learning using one or more of the supervised, un-supervised, reinforcement learning processes.

The AI/ML system or module may be used in, at least part of, the method of adjusting an operational parameter as described herein. For example, the AI/ML system or module may be used in, at least part of, adjusting an operational parameter by obtaining, adjusting or applying a profile associated with the device operation based on the obtained water operation value, where the profile may define at least one relationship between the operational parameter and a water operation value. For example, the step of adjusting the profile using artificial intelligence and/or machine learning may be based on the at least one relationship over time. For example, the adjustment of the profile by the AI/ML system or module may be based on one or more of historical relationships, detected patterns, determined predictions etc.

The AI/ML system or module may be used in, at least part of, the method of determining a maintenance device operation as described herein.

The AI/ML system or module may obtain not only water operation values associated with one or more water control devices and/or smart water meters, but also one or more further data values to assist in one or more of the herein described methods. For example, the further data values may be one or more data sets associated with usage patterns of the one or more water control devices, operational hours associated with the building facility, maintenance schedules associated with the one or more water control devices and/or building facility, water shortage or drought data, weather patterns, weather forecast data, environmental data, etc.

Therefore, the AI/ML system or module may, over time, improve one or more device operations of one or more water control devices to enable the one or more water control devices to be effectively operated.

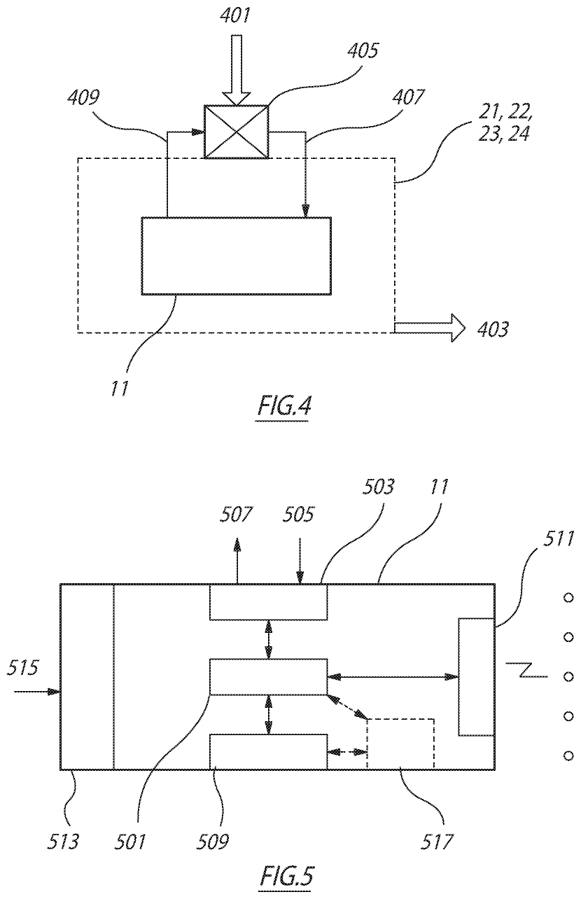

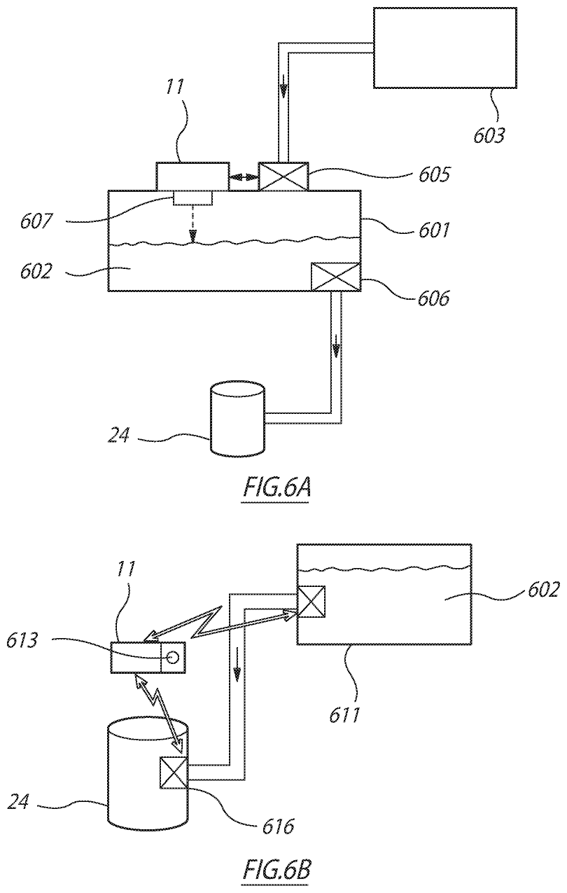

Referring to FIGS. 6A and 6B, two different example scenarios are described in which a water operation value is obtained, where the water operation value is associated with a volume of water for the water control device during the device operation.

In FIG. 6A, a toilet 24 is provided as an example. The toilet has a cistern 601 in which water 602 is provided via a water supply 603 and an inlet water valve 605. A flush valve 606 may be operated (e.g. manually or electronically) to flush the toilet. A controller 11 controls how the inlet water valve operates by communicating one or more operational parameters to the inlet water valve.

In the cistern 601, a water level sensor 607 is provided to sense the water level in the cistern. The sensed water level value is communicated to the controller 11 as a water operation value. The controller determines whether the water operation value is outside of a defined threshold associated with the device operation, which in this scenario is a flush operation.

Upon the controller making a determination that the water operation value is outside of the defined threshold, an operational parameter that is associated with the toilet during the flush operation is adjusted. In this scenario, the operational parameter may be a time period that the inlet water valve is open in order to top up the cistern, a time period that the inlet water valve is closed in order to top up the cistern, a sequence of time periods in which the inlet water valve is open and closed in order to top up the cistern, a flow rate associated with the inlet water valve in order to top up the cistern, or any combination thereof. Adjusting how the inlet water valve operates enables sufficient water to be provided in the cistern for the flush operation, whether it be the current flush operation or one or more subsequent flush operations.

The determination by the controller that the associated water level in the cistern is below a threshold may mean that the volume of water in the cistern would not provide sufficient water in a flush operation, i.e. the volume of water associated with the flush operation is insufficient (below a defined threshold) to enable the water control device to be effectively operated.

It will be understood that the water operation value in the above scenario may be a sensed water volume value that is determined based on the sensed distance between the sensor 607, the water level and the dimensions of the cistern. Further alternatives are envisaged. For example, the water level may be determined using a laser system to detect any height variation in the “normal” water level in the cistern.

In FIG. 6B, a toilet 24 is provided as an example water control device. The toilet is in fluid communication with a header 611 in which water 602 is provided via a building water supply (not shown). An inlet water valve 616 may be operated (e.g. manually or electronically) to flush the toilet, such as, for example, a flush button 613 may be pressed to activate the flush operation. A controller 11 controls how the inlet water valve operates by communicating one or more operational parameters to the inlet water valve.

In the header 611, an outlet water valve (or shut-off valve) 615 provides the water to the inlet water valve 616 of the toilet. In this example, a pressure sensor is incorporated into the outlet water valve to sense the pressure of the water in the header. The sensed water pressure value is communicated to the controller 11 as a water operation value. The controller determines whether the water operation value is outside of a defined threshold associated with the device operation, which in this scenario is a flush operation.

It will be understood that, as an alternative, the pressure sensor may be located elsewhere in the water supply line prior to the outlet water valve to determine the water pressure at the header. Further, the water pressure value may be obtained by the controller from a smart water meter that is in communication with the controller.

Upon the controller making a determination that the water operation value is outside of the defined threshold, an operational parameter that is associated with the toilet during the flush operation is adjusted. In this scenario, the operational parameter may be a time period that the inlet water valve is open to provide sufficient water to the toilet, a time period that the inlet water valve is closed to provide sufficient water to the toilet, a sequence of time periods in which the inlet water valve is open and closed to provide sufficient water to the toilet, a flow rate associated with the inlet water valve to provide sufficient water to the toilet, or any combination thereof. Adjusting how the inlet water valve operates enables sufficient water to be provided to the toilet for the flush operation, whether it be the current flush operation or one or more subsequent flush operations.

For example, the determination by the controller that the water pressure level at the header is below a threshold means that the volume of water provided to the toilet would not provide sufficient water in a flush operation, i.e. the pressure of water associated with the flush operation is insufficient (below a defined threshold) to enable the water control device to be effectively operated. As an example, a sufficient flush operation may require a defined volume of water.

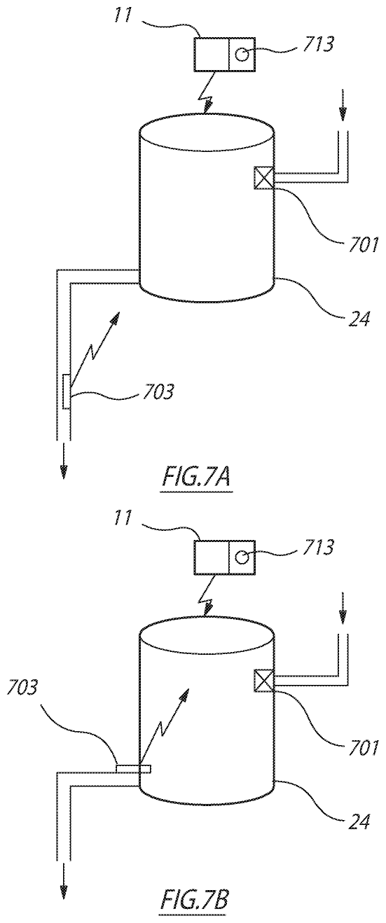

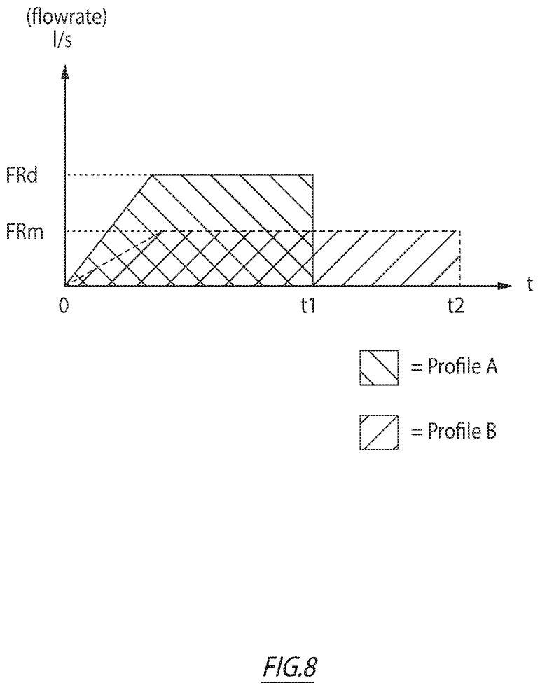

FIGS. 7A and 7B show examples of how a water control device cleanse operation may be controlled.

In FIG. 7A, a toilet 24 is provided as an example water control device. The toilet is in fluid communication with an inlet water valve 701 that provides water for a flush operation. The inlet water valve 701 may be operated (e.g. manually or electronically) to flush the toilet, for example, a flush button 713 may be pressed to activate the flush operation. A controller 11 controls how the inlet water valve operates by communicating one or more operational parameters to the inlet water valve.

In this example, a drain flow rate sensor 703 is incorporated into the drain pipe of the toilet to sense the flow rate of the water passing through the drain pipe. The sensed water flow rate value is communicated to the controller 11 as a water operation value. The controller determines whether the water operation value is outside of a defined threshold associated with the device operation, which in this scenario is draining following a flush operation.

It will be understood that, as an alternative, the flow rate sensor 703 may be located elsewhere such as at the drain outlet of the toilet 24 as shown in FIG. 7B. Further, the water flow rate value may be obtained by the controller from a smart water meter that is in communication with the controller.

Upon the controller making a determination that the water operation value is outside of the defined threshold, an operational parameter that is associated with the toilet is adjusted. In this scenario, the operational parameter may be a time period that the inlet water valve 701 is open, a time period that the inlet water valve is closed, a sequence of time periods in which the inlet water valve is open and closed, a flow rate associated with the inlet water valve, or any combination thereof. Adjusting how the inlet water valve operates may enable sufficient water to be provided to the toilet to enable the draining following the flush operation to work effectively. For example, a high-pressure blast of water may be provided to the toilet in short sharp bursts, in any desired sequence, to try and clear the drain pipe. The operational parameter may be adjusted for the current drain operation or one or more subsequent drain operations.

Alternatively, the adjustment of the operational parameter may be to close off the water inlet valve and/or a shut-off valve until remedial action has been carried out to clear the blockage in the drain pipe, and so enable the water control device to operate effectively.

The determination by the controller that the water flow rate level in the drain is below a threshold may mean that the volume of water currently being provided to the toilet may result in the toilet overflowing. Therefore, the remedial action of attempting to clear the drain pipe, may enable the water control device to be effectively operated. Other actions as described herein may also be utilised.

In accordance with the herein described examples or other examples, the determination by the controller that the water operation value is outside of a defined threshold is executed using one or more profiles that are stored in memory.

The operational parameter may be adjusted by, for example, utilising a profile. A profile associated with the water control device may be obtained, read, monitored, updated, modified and/or replaced by the controller and/or the AI/ML module or system. A profile may be stored in any memory in communication with the controller. The controller may be any controller in communication with the water control device. The profile associated with the water control device may be obtained, read, monitored, updated, modified and/or replaced by a computer system, electronic device or BMS in communication with the water control device.

The controller may adjust the operational parameter by selecting, obtaining, adjusting or applying a profile associated with the device operation based on the obtained water operation value. The profile may define at least one relationship between the operational parameter and the water operation value. For example, the profile may be in the form of a look-up table for a particular water operation value associated with a volume of water for the water control device during the device operation.

The relationship may be defined by a flow rate vs time profile, as described herein with reference to FIG. 8.

An example profile in the form of a table for a water pressure water operation value for a urinal is provided below:

Water pressure water operation value
Urinal XYZ No. 123, location N
(Normal operation = 300 kPa)

| Water pressure | Regulated valve opening | Regulated valve timing | |
|---|---|---|---|
| 300 kPa | 100% | 5 | seconds |
| 300 kPA | 50% | 10 | Seconds |
| 300 kPa | 20% | 25 | seconds |

In accordance with the above profile, it can be seen that the expected (normal) water pressure is 300 kPa for Urinal XYZ No. 123 at location N.

By operating a fixed valve (or regulated valve) at 100%, this would require a 5 second valve operation to obtain the desired water volume of 0.8 litres for a flush operation. For a regulated valve, the valve may be regulated at 50% for 10 seconds to provide the same volume of water. Alternatively, the regulated valve may be regulated at 20% for 25 seconds to provide the same volume of water.

In a scenario where the water pressure water operation value is sensed at a reduced operation, the controller makes the determination that the water pressure is below a defined threshold and modifies the regulation of the valve or the valve opening time accordingly by adjusting an operational parameter of the valve. For example, if the pressure value sensed is half the value of the normal pressure value, the operational parameter of time may be doubled to achieve the same water volume in the device operation. As another example, if the pressure value sensed is double the value of the normal pressure value, the operational parameter of valve regulation may be adjusted from 100% to 50% to achieve the same water volume in the device operation. As another example, if the pressure value sensed is a quarter the value of the normal pressure value, the operational parameter of flow rate may be adjusted four-fold to achieve the same water volume in the device operation. It will be clear that many other scenarios may exist where the detected water pressure increases or decreases.

The controller may also update/modify the profile to insert new “normal” operating parameters. For example, the update may occur if it is determined that the change in pressure is a long-term change.

It will also be understood that different profiles may be provided for other water operation values as well as water pressure values, such as water volume values, water flow rate values and water level values as described herein.

The controller may, upon a determination that the water operation value is outside of a defined threshold, generate and output one or more alerts, messages, communications, instructions or any other communication associated with the water operation value. For example, a communication may be generated and communicated to a computing device, electronic device or BMS to indicate that a change in the water operation value has occurred and that a remedial action may be required. For example, the communication may indicate that a maintenance action, repair action, investigation action, replace action is required. The communication may identify the associated water control device using any of the available data described herein including for example, a device ID and location.

According to one example, a maintenance event may be generated to drain a supply line and refill the supply line. According to another example, a maintenance event may be generated to drain a waste line. According to another example, a maintenance event may be generated to send a technician to investigate. According to another example, a maintenance event may be generated to perform a remedial action. According to another example, a maintenance event may be generated to put a water control device out of action by deactivating a water inlet valve and/or a shut off valve. For example, an individual water control device may be put out of action. As another example, a group of water control devices may be put out of action by shutting off a shut off valve to a sanitary facility or building facility. For example, the group of water control devices may be in the same location or building facility. For example, the group of water control devices may be on the same floor in a building facility. For example, the group of water control devices may be the same product type.

Further, the adjusting of the operational parameter may also include the step controlling the inlet water valve to perform a maintenance device operation. For example, the maintenance device operation may be a cleaning flush of a urinal or toilet, such as, for example, applying a maximum flow rate flush device operation for a defined period of time. As another example, the maintenance device operation may be the automatic shutting off of a shut off valve or inlet water valve associated with a water control device, for example. The shut off valve may be associated with one or more water control devices. The shut off valve may be associated with one or more sanitary facilities in one or more locations and one or more building facilities.

It will be understood that the maintenance device operation to be executed may be determined using the AI/ML module or system based on multiple water operation values that have been obtained from multiple water control devices.

For example, the maintenance device operation may be determined by AI/ML module or system determining where a blockage is occurring in the building facility based on the analysis of water pressure values and/or flow rate values at different points throughout the building facility, in specific areas, at different inlets, at different outlets, at different water control devices etc.

It will also be understood that the step of adjusting, updating or modifying the profile may be executed using the herein described AI/ML system or module based on the at least one relationship over time.

Further, it will be understood that the profile may be associated with one or more of a water control device mode of operation, water control device code, a water control device type, a water control device group, a unique water control device ID, a location of a water control device.

That is, the water control device code may relate to a specific product line (e.g. a product code) such as toilet XYZ. Further, the water control device type may relate to a particular type of product, such as a toilet, a cistern a shower, a tap etc. Further, the water control device group may relate to a group of products such as, bathroom products, toilet products, kitchen products etc. Further, the unique water control device ID may relate to one specific item of a specific product, for example a serial number. Further, the location of the water control device may relate to a specific latitude/longitude location, an address location, a customer location, a floor location etc.

In accordance with the herein described method and system, the inlet water valve may be a fixed flow rate valve, in which case, in one example, the only operational parameters that may be changed may be the parameters associated with the time period(s) that the inlet water valve is switched on and off.

Alternatively, the inlet water valve may be a regulated valve, in which case the operational parameters that may be changed are the time period(s) that the inlet water valve is switched on and off and/or the flow rate associated with the inlet water valve. For example, the flow rate may be a percentage value that indicated how “open” the valve should be. For example, a 100% flow rate indicates that the valve should be fully open, a 50% flow rate indicates that the valve is half open, and a 0% flow rate indicates that the valve is fully closed. As another example, the flow rate operational parameter may be set using standard flow rate values defined in litres/second or an imperial equivalent. The valve may then adjust the flow rate accordingly by opening/closing the inlet/outlet or diaphragm of the valve.

Other scenarios are envisaged for device operations of any of the water control devices described herein in which the water operation value is associated with a volume of water for the water control device during the device operation. The water operation value may be one or more of an inlet water pressure at the water control device, a water supply pressure value associated with a water supply for the water control device, a water level of the volume of water associated with the device operation, an inlet flow rate associated with the device operation, an outlet flow rate associated with the device operation and a water volume associated with the device operation.

Other scenarios are envisaged for device operations of any of the water control devices described herein in which the operational parameter may be at least one water regulating value of an inlet water valve associated with the device operation. Further, the water regulating value may be a time value associated with the device operation, where the time value is one or more of an inlet water valve on-time, an inlet water valve off-time, a sequence of an inlet water valve on-time and off-time. Further, the water regulating value may be a flow rate value of the inlet water valve associated with the device operation.

It will be understood that the operational parameter may be adjusted using the AI/ML module or system as described herein.

In relation to a device operation of any scenario using one or more water control devices, enabling the water control device to be effectively operated may mean operating in accordance with one or more manufacture specifications associated with the water control device so that the volume of water during the device operation is in accordance with the one or more manufacture specifications.

In relation to a device operation of any scenario using one or more water control devices, enabling the water control device to be effectively operated may mean operating in accordance with one or more technical standards associated with the water control device so that the volume of water during the device operation is in accordance with the one or more technical standards.

In relation to a device operation of any scenario scenarios using one or more water control devices, enabling the water control device to be effectively operated may mean operating in accordance with one or more legal standards associated with the water control device so that the volume of water during the device operation is in accordance with the one or more legal standards.

FIG. 8 shows an example of a flow rate profile for a water control device in accordance with the herein described methods and system.

The profile shown in FIG. 8 provides an example of defining at least one relationship between the operational parameter and the water operation value. For example, the water operation value is flow rate (litres/sec) and the operational parameter is time (seconds) that the inlet water valve is open. In profile A of FIG. 8 a standard water pressure is available at the inlet water valve and so the valve operates by ramping up to a defined flow rate FRd. When the current water operation value is detected as being half that of the standard water operation value (i.e. FRm for modified flow rate), profile B is used in which the time of operation of the valve is extended two-fold (from t₁ to t₂) to ensure that the correct volume of water is used in the device operation.

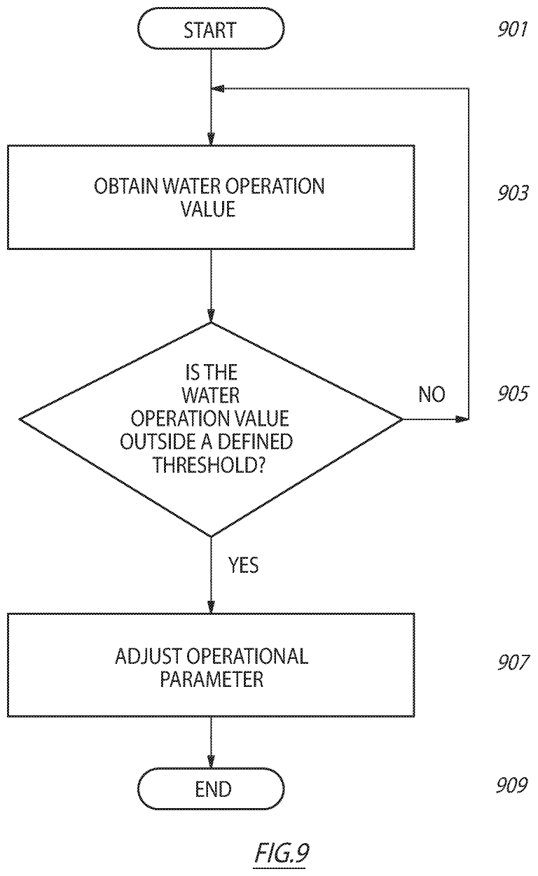

FIG. 9 shows an example of a control process (method) in accordance with the herein disclosure.

The process starts at step 901. At step 903, a water operation value is obtained. At step 905, a determination is made whether the water operation value is outside of a defined threshold. If the determination is “NO”, the process moves back to the start. If the determination is “YES”, the process moves to step 907 where an operational parameter is adjusted. The process finishes at step 909.

In accordance with the at least one inlet water valve control, the adjusting of the operational parameter may include the step of controlling the at least one inlet water valve associated with the water control device based on the obtained water operation value. For example, the inlet water valve may be part of a cistern with a separate release valve into the toilet or urinal. Alternatively, the inlet water valve may be directly in line with the urinal or toilet. Further, the operational parameter may include one or more of a time period that the inlet water valve is open, a time period that the inlet water valve is closed, a sequence of time periods in which the inlet water valve is open and closed, a flow rate of the inlet water valve, or any combination thereof.

Therefore, a water outlet of the inlet water valve may be in direct fluid connection with the water control device. A water inlet of the inlet water valve may be connected to a header. The water outlet of the inlet water valve may be in indirect fluid connection with the water control device. The water outlet of the inlet water valve may be connected to an inlet of a cistern, where the cistern provides the volume of water for the water control device during the device operation.

It will be understood that the herein described system may include a method of obtaining the water operation value by detecting a volume of water that was previously used by the water control device during one or more previous device operations. The operational parameter associated with the volume of water to be used by the water control device may be adjusted by a controller in one or more subsequent device operations to enable the water control device to be effectively operated.

It will be understood that the herein described system may include a method of obtaining the water operation value by obtaining a water pressure value of water associated with the device operation. The method may also include the steps of a controller obtaining a previous water pressure value, comparing the obtained water pressure value with the obtained previous water pressure value and determining whether the water pressure value is outside of the defined threshold based on a calculated pressure difference value based on a difference in water pressure between the water pressure value and the previous water pressure value.

For example, the water pressure value may be obtained by capturing a real-time measurement, or a measurement that was taken any time prior to the device operation, including an average value over time.

The water pressure value may be obtained from any memory that is in communication with the controller. For example, this value could be a measurement that was captured during a current device operation to change how the device operates in subsequent device operations. Further, this value could be an average of recent prior measurements to be used to adjust how the device operates in the next device operation.

The water pressure value may be obtained from one or more smart water meters.

It will be understood that the herein described system may include a method of obtaining the water operation value by obtaining a water flow rate value of water associated with the device operation. For example, the water flow rate value may be based on one or more water flow rate values obtained during one or more previous device operations. For example, the water flow rate value may be an average, mean or any other suitable mathematical determination of previously obtained waterflow rate values. The water flow rate value may be determined by the AI/ML module or system. The water flow rate value may be obtained from one or more smart water meters.

The water flow rate value may be obtained by capturing a real-time measurement, or a measurement that was taken any time prior to the device operation, including an average value over time.

The water flow rate value may be obtained from any memory that is in communication with the controller. For example, this value could be a measurement that was captured during a current device operation to change how the water control device operates in subsequent device operations.

Further, this value could be an average of recent prior measurements to be used to adjust how the water control device operates in the next device operation.

It will be understood that the herein described system may include a method of obtaining the water operation value by obtaining a water level value of water associated with the device operation.

The water level value may be obtained by capturing a real-time measurement, or a measurement that was taken any time prior to the device operation, including an average value over time.

The water level value may be obtained from any memory that is in communication with the controller. For example, this value could be a measurement that was captured during a current device operation to change how the water control device operates in subsequent device operations.

Further, this value could be an average of recent prior measurements to be used to adjust how the water control device operates in the next device operation.

The water control devices may also perform device operations using any of a plurality of modes of operation that are available for that particular water control device. Therefore, the adjusting of the operational parameter for the device operation may also be dependent on a selected mode of operation selected from the modes of operation.

For example, the mode of operation may be a mode X, mode Y, mode Z, where these modes are identified as standard mode, cleansing mode, maintenance mode, for example.

Different profiles may be stored in any memory that is in communication with the controller to determine how the water control device is to execute the device operation.

For example, the following table provides an example of different profiles that may be utilised by the herein described system using the herein described methods depending on the mode of operation of the water control device.

| WATER CONTROL | | | |
|---|---|---|---|
| DEVICE | MODE X | MODE Y | MODE Z |
| A | PROFILE_{AX} | PROFILE_{AY} | PROFILE_{AZ} |
| B | PROFILE_{BX} | PROFILE_{BY} | PROFILE_{BZ} |
| C | PROFILE_{CX} | PROFILE_{CY} | PROFILE_{CZ} |
| D | PROFILE_{DX} | PROFILE_{DY} | PROFILE_{DZ} |

As an example, for water control device C, which may be Urinal XYZ No. 123, location N as described above, there are three different mode related profiles stored depending on whether the urinal is being operated in Mode X (standard mode), Mode Y (cleansing mode) or Mode Z (maintenance mode). For example, if the Urinal XYZ is operated in cleansing mode then PROFILE_{CY} is used in the methods described herein.

In this way, accurate profiles may be applied to different water control devices dependent on the mode of operation of the water control device.

For example, the following table provides an example of different profiles that may be utilised by the herein described system using the herein described methods depending on the location of the water control device.

| WATER CONTROL | | | |
|---|---|---|---|
| DEVICE | LOCATION M | LOCATION N | LOCATION O |
| A | PROFILE_{AM} | PROFILE_{AN} | PROFILE_{AO} |
| B | PROFILE_{BM} | PROFILE_{BN} | PROFILE_{BO} |
| C | PROFILE_{CM} | PROFILE_{CN} | PROFILE_{CO} |
| D | PROFILE_{DM} | PROFILE_{DN} | PROFILE_{DO} |

As an example, for water control device C, which may be Urinal XYZ No. 123 there are three different mode related profiles stored depending on where the urinal is installed (i.e. located). For example, if Urinal XYZ No. 123 is commissioned at location N, then PROFILE_{CN} is used in the methods described herein. If the urinal is decommissioned and installed elsewhere (e.g. location O, then an alternative profile may be used (i.e. PROFILE_{CO}).

In this way, accurate profiles may be applied to different water control devices dependent on the water control device and/or its location.

It will be understood that profile tables may be specific to product types of water control device, e.g. urinal, toilet, shower, tap etc.

It will be understood that a combination of the herein described profile tables may be used to produce individual profiles based on any combination of mode of operation, location of the water control device, type of water control device etc.

An example of the herein described methods being used where the water control device is a tap, shower, bath, bidet, water heater system or water cooling tower is now provided. In this scenario, the tap, shower, bath, bidet, water heater system or water cooling tower may have a defined volume of water that it can use before it is automatically shut off in accordance with the effective operation of the tap, shower, bath, bidet, water heater system or water cooling tower. The system may therefore monitor one or more water operation values associated with the tap, shower, bath, bidet, water heater system or water cooling tower to determine how to adjust the operational parameters (e.g. how a valve is operated) to provide the defined volume of water.

### INDUSTRIAL APPLICABILITY

The arrangements described are applicable to the building management systems industries and particularly for the sanitary facility management industry.

The foregoing describes only some embodiments of the present invention, and modifications and/or changes can be made thereto without departing from the scope and spirit of the invention, the embodiments being illustrative and not restrictive.

In the context of this specification, the word “comprising” means “including principally but not necessarily solely” or “having” or “including”, and not “consisting only of”. Variations of the word “comprising”, such as “comprise” and “comprises” have correspondingly varied meanings.

1. A building facility water management method for controlling at least one operational parameter associated with a volume of water used by a water control device during a device operation of the water control device in a building facility, the method comprising the steps of:
obtaining a water operation value associated with a volume of water for the water control device during the device operation;
determining whether the water operation value is outside of a defined threshold associated with the device operation;
upon a determination that the water operation value is outside of the defined threshold, adjusting an operational parameter associated with the water control device during the device operation to enable the water control device to be effectively operated.

2. (canceled)

3. (canceled)

4. The method of claim 1, wherein the water operation value is one or more of an inlet water pressure at the water control device, a water supply pressure value associated with a water supply for the water control device, a water level of the volume of water associated with the device operation, an inlet flow rate associated with the device operation, an outlet flow rate associated with the device operation, a water volume associated with the device operation, a measured real-time water operation value, and a stored water operation value.

5. (canceled)

6. The method of claim 1, wherein the at least one operational parameter comprises at least one water regulating value of an inlet water valve associated with the device operation, the water regulating value is a time value associated with the device operation comprising one or more of an inlet water valve on-time, an inlet water valve off-time, a sequence of an inlet water valve on-time and off-time, or wherein the water regulating value is a flow rate value of the inlet water valve associated with the device operation.

7-9. (canceled)

10. The method of claim 1, wherein the adjusting of the operational parameter adjusts the volume of water available to the water control device to complete the device operation and/or subsequent device operations.

11. The method of claim 1, wherein the adjusting of the operational parameter comprises the step of controlling at least one inlet water valve associated with the water control device, wherein the controlling of the inlet water valve is based on the obtained water operation value.

12. The method of claim 11, wherein the operational parameter comprises one or more of a time period that the inlet water valve is open, a time period that the inlet water valve is closed, a sequence of time periods in which the inlet water valve is open and closed, a flow rate of the inlet water valve, or any combination thereof.

13. The method of claim 11, wherein the adjusting of the operational parameter comprises the step of controlling the at least one inlet water valve to perform a maintenance device operation.

14. The method of claim 13, wherein the maintenance device operation is determined using artificial intelligence and/or machine learning based on a plurality of water operation values obtained from a plurality of water control devices.

15. The method of claim 11, wherein a water outlet of the inlet water valve is in direct fluid connection with the water control device and a water inlet of the inlet water valve is connected to a header.

16. (canceled)

17. The method of claim 11, wherein the water outlet of the inlet water valve is in indirect fluid connection with the water control device and the water outlet of the inlet water valve is connected to an inlet of a cistern, where the cistern provides the volume of water for the water control device during the device operation.

18. (canceled)

19. The method of claim 1, wherein the step of obtaining the water operation value comprises detecting a volume of water that was previously used by the water control device during one or more previous device operations, and
adjusting the operational parameter associated with the volume of water to be used by the water control device in one or more subsequent device operations to enable the water control device to be effectively operated.

20. The method of claim 1, wherein the step of obtaining the water operation value comprises obtaining a water pressure value of water associated with the device operation, obtaining a water flow rate value of water associated with the device operation, or obtaining a water level value of water associated with the device operation.

21. The method of claim 1, wherein the method further comprises the steps of:
obtaining a previous water pressure value;
comparing the obtained water pressure value with the obtained previous water pressure value and
determining whether the water pressure value is outside of the defined threshold based on a calculated pressure difference value based on a difference in water pressure between the water pressure value and the previous water pressure value.

22. (canceled)

23. The method of claim 19, wherein the water flow rate value is based on one or more water flow rate values and obtained during one or more previous device operations.

24. (canceled)

25. The method of claim 1, wherein enabling the water control device to be effectively operated comprises the step of operating in accordance with one or more manufacture specifications associated with the water control device so that the volume of water during the device operation is in accordance with the one or more manufacture specifications, or
wherein enabling the water control device to be effectively operated comprises the step of operating in accordance with one or more technical standards associated with the water control device so that the volume of water during the device operation is in accordance with the one or more technical standards, or
wherein enabling the water control device to be effectively operated comprises the step of operating in accordance with one or more legal standards associated with the water control device so that the volume of water during the device operation is in accordance with the one or more legal standards.

26. (canceled)

27. (canceled)

28. The method of claim 1, wherein the adjusting of the operational parameter comprises selecting, obtaining, adjusting or applying a profile associated with the device operation based on the obtained water operation value and the profile defines at least one relationship between the operational parameter and the water operation value.

29. (canceled)

30. The method of claim 28, the method further comprising the step of adjusting the profile using artificial intelligence and/or machine learning based on the at least one relationship over time.

31. The method of claim 28, wherein the profile is associated with one or more of a water control device mode of operation, water control device code, a water control device type, a water control device group, a unique water control device ID, a location of a water control device.

32. The method of claim 1, wherein the device operation comprises a plurality of modes of operation, and the adjusting of the operational parameter for the device operation is dependent on a selected mode of operation selected from the modes of operation.

33. A building facility water management system for controlling at least one operational parameter associated with a volume of water used by a water control device during a device operation of the water control device in a building facility, the system comprising at least one water control device and at least one controller, wherein the controller is arranged to:
obtain a water operation value associated with a volume of water for the water control device during the device operation;
determine whether the water operation value is outside of a defined threshold associated with the device operation;
upon a determination that the water operation value is outside of the defined threshold, adjust an operational parameter associated with the water control device during the device operation to enable the water control device to be effectively operated.

34. The system of claim 33, wherein the controller is a water control device controller, a computer system controller, an electronic device controller, a building management system controller or a server controller.

35. (canceled)

36. (canceled)

37. The system of claim 33, wherein the water operation value is one or more of an inlet water pressure at the water control device, a water supply pressure value associated with a water supply for the water control device, a water level of the volume of water associated with the device operation, an inlet flow rate associated with the device operation, an outlet flow rate associated with the device operation, a water volume associated with the device operation, a measured real-time water operation value, and a stored water operation value.

38. (canceled)

39. The system of claim 33, wherein the at least one operational parameter comprises at least one water regulating value of an inlet water valve associated with the device operation, wherein the water regulating value is a time value associated with the device operation comprising one or more of an inlet water valve on-time, an inlet water valve off-time, a sequence of an inlet water valve on-time and off-time, or wherein the water regulating value is a time value associated with the device operation comprising one or more of an inlet water valve on-time, an inlet water valve off-time, a sequence of an inlet water valve on-time and off-time, or wherein the water regulating value is a flow rate value of the inlet water valve associated with the device operation.

40-42. (canceled)

43. The system of claim 33, wherein the adjusting of the operational parameter adjusts the volume of water available to the water control device to complete the device operation and/or subsequent device operations.

44. The system of claim 33, wherein the adjusting of the operational parameter comprises the step of controlling at least one inlet water valve associated with the water control device, wherein the controlling of the inlet water valve is based on the obtained water operation value.

45. The system of claim 44, wherein the operational parameter comprises one or more of a time period that the inlet water valve is open, a time period that the inlet water valve is closed, a sequence of time periods in which the inlet water valve is open and closed, a flow rate of the inlet water valve, or any combination thereof.

46. The system of claim 44, wherein the adjusting of the operational parameter comprises the step of controlling the at least one inlet water valve to perform a maintenance device operation.

47. The system of claim 46, wherein the maintenance device operation is determined using artificial intelligence and/or machine learning based on a plurality of water operation values obtained from a plurality of water control devices.

48. The system of claim 44, wherein a water outlet of the inlet water valve is in direct fluid connection with the water control device and a water inlet of the inlet water valve is connected to a header.

49. (canceled)

50. The system of claim 44, wherein the water outlet of the inlet water valve is in indirect fluid connection with the water control device, and the water outlet of the inlet water valve is connected to an inlet of a cistern, where the cistern provides the volume of water for the water control device during the device operation.

51. (canceled)

52. The system of claim 33, wherein the controller is arranged to obtain the water operation value by detecting a volume of water that was previously used by the water control device during one or more previous device operations, and further arranged to
adjust the operational parameter associated with the volume of water to be used by the water control device in one or more subsequent device operations to enable the water control device to be effectively operated.

53. The system of claim 33, wherein the controller is arranged to
obtain the water operation value by obtaining a water pressure value of water associated with the device operation,
obtain the water operation value by obtaining a water flow rate value of water associated with the device operation, or
obtain the water operation value by obtaining a water level value of water associated with the device operation.

54. The system of claim 33, wherein the controller is further arranged to:
obtain a previous water pressure value;
compare the obtained water pressure value with the obtained previous water pressure value and
determine whether the water pressure value is outside of the defined threshold based on a calculated pressure difference value based on a difference in water pressure between the water pressure value and the previous water pressure value.

55. (canceled)

56. The system of claim 53, wherein the water flow rate value is based on one or more water flow rate values and obtained during one or more previous device operations.

57. (canceled)

58. The system of claim 33, wherein the controller being arranged to enable the water control device to be effectively operated comprises the controller operating the water control device in accordance with one or more manufacture specifications associated with the water control device so that the volume of water during the device operation is in accordance with the one or more manufacture specifications, or
wherein the controller being arranged to enable the water control device to be effectively operated comprises the controller operating the water control device in accordance with one or more technical standards associated with the water control device so that the volume of water during the device operation is in accordance with the one or more technical standards, or
wherein the controller being arranged to enable the water control device to be effectively operated comprises the controller operating the water control device in accordance with one or more legal standards associated with the water control device so that the volume of water during the device operation is in accordance with the one or more legal standards.

59. (canceled)

60. (canceled)

61. The system of claim 33, wherein the controller is arranged to adjust the operational parameter by selecting, obtaining, adjusting or applying a profile associated with the device operation based on the obtained water operation value and the profile defines at least one relationship between the operational parameter and the water operation value.

62. (canceled)

63. The system of claim 61, wherein the controller is further arranged to adjust the profile using artificial intelligence and/or machine learning based on the at least one relationship over time.

64. The system of claim 61, wherein the profile is associated with one or more of a water control device mode of operation, water control device code, a water control device type, a water control device group, a unique water control device ID, a location of a water control device.

65. The system of claim 33, wherein the device operation comprises a plurality of modes of operation, and the controller is arranged to adjust the operational parameter for the device operation dependent on a selected mode of operation selected from the modes of operation.
